(19) United States
(12) Patent Application Publication
(10) Pub. No.: US 2013/0236757 A1
(43) Pub. Date: Sep. 12, 2013

(54) CELL ASSEMBLIES WITH NEUTRAL CASES

(71) Applicant: LEYDEN ENERGY, Fremont, CA (US)

(72) Inventors: Konstantin Tikhonov, Pleasanton, CA (US); Hashmatullah Haidari, Fremont, CA (US); Norman Lei, San Francisco, CA (US)

(73) Assignee: LEYDEN ENERGY, Fremont, CA (US)

(21) Appl. No.: 13/787,704

(22) Filed: Mar. 6, 2013

Related U.S. Application Data
(60) Provisional application No. 61/608,054, filed on Mar. 7, 2012.

(51) Int. Cl. H01M 2/02

(52) U.S. Cl. CPC H01M 2/0257
USPC 429/94; 29/623.2

(57) ABSTRACT

Provided are electrochemical cell assemblies and methods of fabricating thereof. A cell assembly includes an anode containing lithium titanium oxide and a cathode forming a jellyroll together with the anode. Each of the electrodes is connected to a separate cap and electrically insulated from the case. As such, the case is electrochemically neutral and may be made from a larger selection of materials. For example, a case may be made from steel that would otherwise dissolve if exposed to the anode potential during cycling of the battery. Some of these case materials simplify processing and sealing characteristics. In certain embodiments, a case may be crimped around each of the caps and corresponding gaskets to provide sealing interfaces. The caps or at least their surfaces exposed to the electrolyte are made from materials that are electrochemically stable at corresponding potentials of the electrodes.

### CROSS-REFERENCE TO RELATED APPLICATION

This application claims the benefit of priority to U.S. Provisional Application No. 61/608,054, titled “CELL ASSEMBLIES WITH NEUTRAL CASES,” filed Mar. 7, 2012, all of which is incorporated herein by this reference.

### BACKGROUND

In a typical cylindrical battery, the case is electrically connected to either a positive or negative electrode and is used as an electrical conductor between this electrode and external electrical leads of the cell or battery pack. Another electrode may be connected to a cap or feed through assembly, which is electrically insulated from the case by providing an insulating component in between the case and electrode. The case may be crimped around the cap by using an insulating gasket to seal the case. When the feed through assembly is used, the external enclosure may be welded to or otherwise attached to the case or another component maintaining electrical communication with the case.

Selection of case and header materials are limited by electrochemical potentials produced inside the cell. When a case is connected to an electrode and is exposed to electrolyte, it may be subjected to electrochemical dissolution and effectively become a sacrificial electrode. For example, a case made from steel or nickel plated steel may withstand electrochemical potentials of conventional lithium ion anode active materials, such as carbon-based negative materials. However, steel and nickel may dissolve when subjected to electrochemical potentials associated with lithium titanium oxide (LTO)-based anode active materials.

### SUMMARY

Provided are electrochemical cell assemblies and methods of fabricating such assemblies. A cell assembly includes an anode containing lithium titanium oxide and a cathode forming a jellyroll together with the anode. Each of the electrodes is connected to a separate cap and electrically insulated from the case. As such, the case is electrochemically neutral and may be made from a larger selection of materials. For example, a case may be made from steel that would otherwise dissolve if exposed to the anode potential during cycling of the battery. Some of these case materials simplify processing and sealing characteristics. In certain embodiments, a case may be crimped around each of the caps and corresponding gaskets to provide sealing interfaces. The caps or at least their surfaces exposed to the electrolyte are made from materials that are electrochemically stable at corresponding potentials of the electrodes.

These and other embodiments are described further below with reference to the figures.

### BRIEF DESCRIPTION OF THE DRAWINGS

FIG. 1A is a top schematic representation of a wound jelly roll provided inside a case, in accordance with certain embodiments.

FIG. 1B is a side schematic representation of an electrochemical cell assembly illustrating two caps connected to the electrodes and insulated from a case crimped around the two caps, in accordance with certain embodiments.

FIG. 1C is a side schematic representation of an electrochemical cell assembly illustrating two caps that are connected to the electrodes and insulated from the case, in accordance with certain embodiments.

FIG. 2A is a side schematic representation of a cap having a body made from material that is electrochemically stable at operating potentials of the corresponding electrode, in accordance with certain embodiments.

FIG. 2B is a side schematic representation of a cap having an electrolyte facing surface formed by a layer made from material that is electrochemically stable at operating potentials of the corresponding electrode, in accordance with certain embodiments.

FIG. 3 is a process flowchart corresponding to a method of fabricating an electrochemical cell assembly, in accordance with certain embodiments.

FIG. 4 is a plot representing cell cycling at room temperature, in accordance with certain embodiments.

FIG. 5 is a plot representing cell cycling at an elevated temperature, in accordance with certain embodiments.

FIG. 6 is a plot showing capacity vs. cycle number for a case-negative cell and case-neutral cell cycling at 60° C.

### DETAILED DESCRIPTION OF EXAMPLE EMBODIMENTS

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with specific embodiments, it will be understood that these embodiments are not intended to be limiting.

Provided are electrochemical cell assemblies having negative and positive electrodes electrically connected to the negative and positive caps and electrically insulated from the case. Various insulating seals may be provided in between the case and each of the caps. The case remains electrically neutral with respect to the electrolyte provided in such assemblies. The electrically neutral case may be made from certain materials, such as steel, that would have been unstable if the case were connected to either one of the electrodes. At the same time, conventional case materials may be used with new active materials that operate at different electrochemical potentials. Overall, the electrical isolation of the case and electrodes allows greater flexibility in selection of electrochemically active materials and case materials and provides new cell design opportunities.

In certain embodiments, an electrically neutral case may be used to achieve more precise control over charging and discharging conditions. In certain embodiments, the case may be coupled to a reference electrode to eliminate floating potential within the cell assembly and/or to provide an external reference terminal.

### Crimping Example

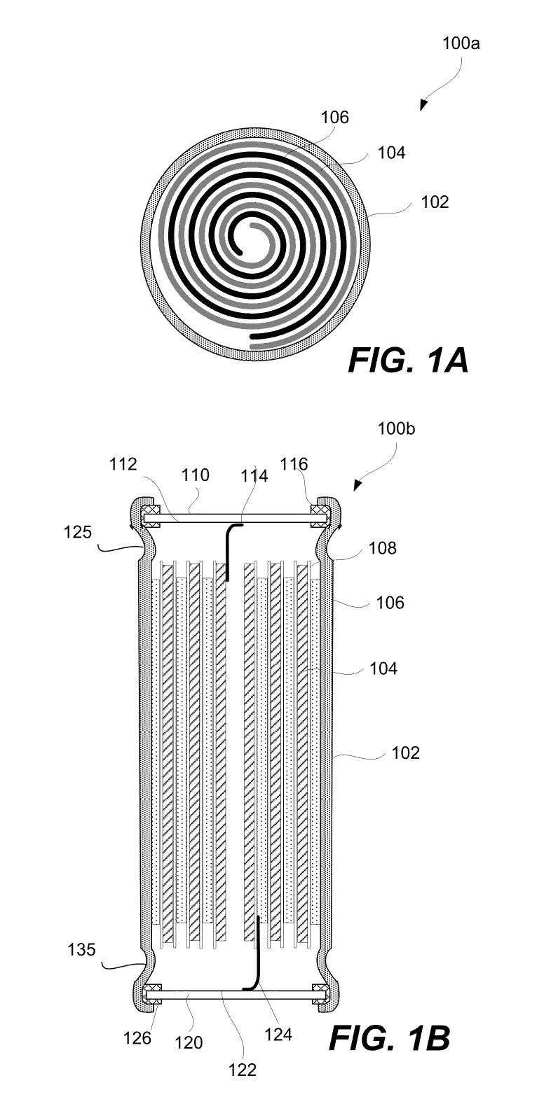

An electrochemical cell assembly includes an anode and a cathode. The two electrodes may be wound into a jellyroll subassembly, which also includes a separator provided between and electrically insulating the two electrodes. The separator allows ions-in electrolyte to flow between the two electrodes. FIG. 1A is a top schematic representation of a wound jellyroll 100a provided inside the case 102, in accordance with certain embodiments. The two electrodes are schematically represented by lines 104 and 106. The separator and contacts are not shown for clarity of the figure. The length of the electrodes depend on the inner diameter of the case and may be between about 200 mm and 1000 mm for an 18650 type of cell. Case 102 may be made from one or more materials that are suitable for crimping. Such materials include, but are not limited to steel, nickel, titanium, and combinations thereof. To be a suitable for crimping, the material should be relatively strong and flexible at the thickness used. For example, aluminum is not a suitable crimping material because at the thickness required to provide the case with sufficient mechanical strength, the aluminum is too thick to effectively crimp.

### Interlocking Features Example

The jellyroll subassembly and electrolyte are enclosed by external cell components such as the case and caps. FIG. 1B is a side schematic representation of an electrochemical cell assembly 100b illustrating two caps 110 and 120 that are electrically connected to the electrodes 104 and 106 and insulated from case 102. The case 102 is crimped around caps 110 and 120, in accordance with certain embodiments. Specifically, cap 110 is shown connected to anode 104 using tab 114. Cap 120 is shown connected to cathode 106 using tab 124. Both electrode caps 110 and 120 are electrically insulated from case 120. For example, polymer seals 116 and 126 may be positioned between case 120 and each one of caps 110 and 120. Case 120 may be crimped around each one of caps 110 and 120 and corresponding seals 116 and 126 to provide mechanical support to caps 110 and 120 and seals 116 and 126 with respect to case 120. The crimping also seals the interfaces between these components by exerting and maintaining a force at this interface. Indentations 125 and 135 are provided in the cell can and are vertically positioned inside the two caps 110 and 120 but outside the jellyroll subassembly. In certain embodiments the crimp may be vertically positioned at the top or bottom of the jellyroll subassembly, rather than being positioned slightly above or below the jellyroll. In any case, the crimp should be designed such that it does not interfere with the functionality of the jellyroll subassembly.

Other features, such as interlocking features, may be used to insulate and seal interfaces between the case and each one of the caps. FIG. 1C is a side schematic representation of an electrochemical cell assembly 130 illustrating two caps 134 and 136 insulated from and supported with respect to case 132 using insulating gaskets 138 and 140 that interlock with protrusions 142 and 144, of case 132 in accordance with certain embodiments. The case does not need to be crimped in this example. In another example, a case may have one end that is crimped over one set of cap and gasket and another end that interlocks with another set of cap and gasket. In any one of these examples, a case remains electrically insulated from each of the caps.

Insulating the Case from the Electrodes

In addition to the case being insulated from each of the caps, the case is also insulated from the electrodes positioned within the case. In certain embodiments, a case may have an insulating material provided on a jellyroll facing surface of the case. In certain embodiments, the case may have a non-conductive coating. In some embodiments, the non-conductive coating comprises a polymer or inorganic material. In some embodiments, the case is anodized metal. In the same or other embodiments, a jellyroll has a case facing surface formed by a separator sheet. Specifically, the separator sheet may extend past both of the electrodes (in terms of the length of the sheet when unrolled) and form an outside wind of the jellyroll when rolled.

### Cap Features

Caps of an electrochemical cell assembly serve as contact points for respective electrodes. As explained above, one cap is connected to one electrode, while another cap is connected to another electrode. In certain embodiments, one or both tabs include one or more safety devices such as a pressure vent, current interrupt device (CID), and/or a positive temperature coefficient (PTC) protective device. One of the caps may also include a fill plug for filling electrolyte through the cap. In other embodiments, electrolyte is filled before one of the caps is sealed with respect to the case. In such embodiments, the other cap is typically attached to the case before electrolyte is introduced.

### Internal Cap Surfaces

Each cap has an electrolyte facing surface (sometimes referred to as an internal surface) and an external surface. These surfaces are opposite to each other and may be formed by the same or different materials. Specifically, the electrode facing surfaces (identified as elements 112 and 122 in FIG. 1B) are typically made from electrochemically stable materials. Selection of these materials depends on several factors such as the active materials provided in the electrodes, the composition of electrolyte, and the operating conditions of the cell (e.g., depth of discharge, discharge rate, temperature, etc.). In certain embodiments, the anode includes lithium titanium oxide. An electrolyte facing surface of the corresponding negative cap may include aluminum. In specific embodiments, the electrolyte facing surface includes an aluminum alloy. An electrolyte facing surface of the corresponding positive cap may also include aluminum. In certain embodiments, the caps connected with the negative and cathode are the same. In other embodiments, the two caps are made from different materials. The caps and the case may be made from the same or different materials. In certain embodiments, at least one cap has an electrolyte facing surface formed by a material that is different than a material forming an electrolyte facing surface of the case.

### External Cap Surfaces

The external surfaces of the caps are used for making electrical connections to the caps. This configuration allows electrical leads to be attached to the cell assembly, and further allows the cell assemblies to be interconnected, such as in a battery pack. As such, the external surfaces of the caps may be formed from materials suitable for such functions. Example materials for forming an external surface, or at least a portion of the external surface, include nickel, titanium, copper, aluminum, gold, steel, stainless steel, or alloys of these metals. Stainless steel and titanium are especially useful where the cell is to be implanted in a living being. In certain cases the material for forming an external surface includes a first material coated with a second material. Where the cell is to be used in a very corrosive environment, the external surface material may include a component designed to protect the cell from such corrosion. It is generally beneficial for this external surface material to have low contact resistance. Further, it is beneficial for the external surface material that allows contacts to be welded to the material through processes such as resistive welding, laser welding, ultrasonic welding or solder.

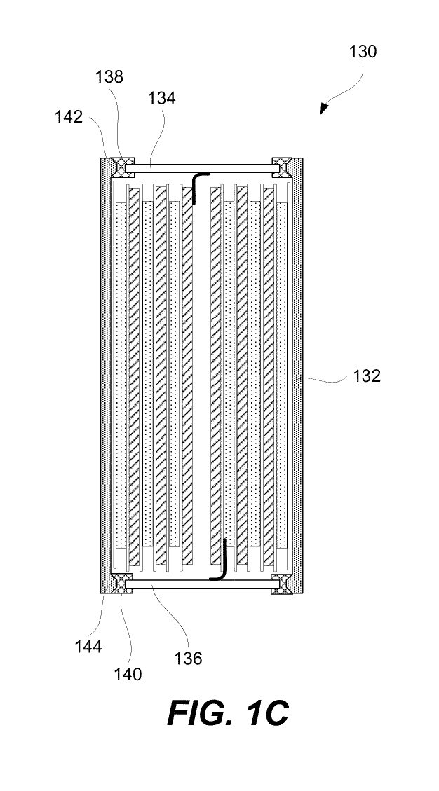

In certain embodiments, an external surface is formed by a material that is different from a material forming an internal surface. In some of these embodiments, one of these materials may be used to form a body of the cap. FIG. 2A is a side schematic representation of a cap 200 having a body 204 made from a material that is electrochemically stable at the operating potentials of the corresponding electrode, in accordance with certain embodiments. As shown in FIG. 2A, body 204 forms an inner surface 210 exposed to the electrolyte. Body 204 has an external surface 208, which is shown to be partially covered by another material 212, which may be more suitable for establishing electrical connections to cap 200 as compared to external surface 208. In certain embodiments, this other material 212 may cover the entire external surface of the cap (not shown). However, this full coverage may not be necessary. Even a partial coverage of the external surface may be suitable for making an electrical connection. In specific embodiments, body 204 is made from aluminum or aluminum alloy, while material 212 forming at least a portion of the external surface is nickel. For example, a layer of nickel may be plated over the entire external surface of the cap or a portion of this surface.

In some embodiments, the material of the body is different from the material forming an internal surface of the cap. FIG. 2B is a side schematic representation of a cap 220 having an electrolyte facing surface 230 formed by a layer 232 made from a material that is electrochemically stable at operating potentials of the corresponding electrode, in accordance with certain embodiments. The body 224 of cap 220 may be made from a different material than the material used for layer 232. If body 224 is not made from an electrochemically stable material, then layer 232 should extend over the entire electrolyte facing surface 230 to prevent contact between the electrolyte and body 224. Body 224 may be made from materials that are suitable for forming external surface 226 and making one or more electrical connections to this surface 226. To be a suitable body material, the material should be able to withstand welding/soldering. Further, the material should be compatible with whatever is in the environment in which the cell will be used. For example, if the cell will be in contact with corrosive media or live tissue, the body material should be able to withstand the corrosive or tissue environment. Most commonly, the body is made of nickel-plated steel, stainless steel, or nickel-plated stainless steel. In other embodiments (not shown), a body of the cap contains a material that is different than one or more materials forming an inner surface and outer surface. Generally, materials used to form the body and both surfaces are all conductive. In certain embodiments, one or both surfaces may have an insulating layer provided thereon. In specific embodiments, body 224 is made from nickel, while layer 232 is formed from aluminum. In some implementations, the cell can contains an indentation 225 below the crimp and above the jellyroll subassembly at the top of the cell, and/or an indentation above the crimp and below the jellyroll subassembly at the bottom of the cell (not shown).

The design (composition and/or configuration) of the negative and positive caps may be the same or different. Using the same types of caps may simplify fabrication of the electrochemical cell assembly as well as simplifying materials sourcing. For example, electrolyte facing surfaces of both caps may be made from aluminum or other suitable material. To be a suitable material for the electrolyte facing surfaces, the material should be resistant to corrosion of the electrolyte at the potentials these surfaces experience. Other factors which affect the selection of material for the electrolyte facing surface include cost, conductivity of the material, and ease of fabrication. The external surface of the cap(s) may include nickel surfaces, tabs, and/or some other features for making electrical connections. In Li-ion cells where LiPF₆ or LiBF₄ are used as electrolyte salts, the electrolyte facing surface on the cathode may be, for example, aluminum. In Li-ion cells where LiTFSI or LiFSI are used as a salt, the electrolyte facing surface on the cathode side may be, for example, Ti or Nb or W. Where graphite is used as the anode material, the electrolyte facing surface on the anode side may be, for example, nickel, copper, steel, or many other options. The options in this case are fairly wide because most materials do not corrode at the low potential used. Where LTO is used as the anode material, the electrolyte facing surface on the anode side may be, for example, aluminum or titanium. Other examples of materials that may be used on the electrolyte facing surfaces include Mo, Sn, and Pb. The examples herein are merely illustrative and are not intended to be limiting.

### Reference Electrode

Even though a case may be electrically disconnected from both electrodes, it may remain at a floating potential and drift to a potential that may cause electrochemical corrosion and other undesirable effects. This drift occurs because when there is no electrochemical process being driven, there is no equilibrium and any small parasitic reactions which occur can cause the potential to float up or down. As an example, if a parasitic reaction results in the generation and continued presence of oxygen within the electrolyte, the potential may float up to about 1.23 V. To avoid such drift, a case may be connected to a third electrode, or more specifically, to a reference electrode made from lithium or other suitable material. Where a Zn rechargeable battery is used, the third electrode may be made of Zn, where a Mg rechargeable battery is used, the third electrode may be made of Mg, etc. Typically, the third electrode may be made from the same material as the cathode. A strip of lithium or other suitable material may be inserted between the case and jellyroll when the jellyroll is inserted into the case. Contact between the case and the strip of lithium may be maintained by the pressure exerted by the jellyroll onto the case, especially after initial swelling of the jellyroll. In this example, the case remains at the potential of the Li/Li⁺ couple, and is protected against corrosion. Some electrochemical corrosion of the reference electrode may be allowed in order to prevent corrosion of the case. In other words, the reference electrode may be used as a sacrificial electrode.

Furthermore, a case connected to a reference electrode may be used as a third cell terminal of the cell to more precisely control charge and discharge states of the cell. In certain embodiments, an electrical current may be applied between this third terminal and either the negative or cathode to drive charge carrying ions between the respective pair of electrodes. This feature may be used to introduce additional lithium into, or remove lithium from, an electrochemical system formed by the negative and cathodes. For example, after formation a cell may experience some depletion of lithium available for cycling. The reference electrode and terminal may be used to replenish lithium available for cycling.

### Cell Assembly Example

A battery with a neutral case may be assembled using a cathode containing an aluminum foil supporting one or more electrode layers. In one embodiment, the electrode layers may have about 92% by weight lithium manganese oxide (LMO) powder (available from TODA America in Battle Creek, Mich.), about 2% by weight SUPER P® conductive carbon black (available from TIMCAL Graphite & Carbon in Bodio, Switzerland), about 3% by weight KS6 graphite (available from TIMCAL Graphite & Carbon in Bodio, Switzerland), and about 3% by weight KF1300 polymer binder (available from KUREHA America Inc. in New York, N.Y.). During electrode preparation, in certain implementations, the above listed chemicals may be mixed into a slurry together with N-Methyl-2-pyrrolidone solvent at about 72% solid content and coated onto aluminum foil that is about 16 micrometers thick. The foil is typically coated on both sides. The thickness of the coating may correspond to about 15 milligrams coating material per centimeter squared of cathode surface area (including both sides of the electrode). The coating film may then be compressed to a density of about 2.5 grams per centimeter cubed.

The battery may also include an anode containing 16 micrometer thick aluminum foil coated with one or more electrode layers containing in one example about 80% by weight lithium titanium oxide powder (available from TODA America in Battle Creek, Mich.), about 5% by weight KS6 graphite (available from TIMCAL Graphite & Carbon in Bodio, Switzerland), about 5% by weight SUPER P® conductive carbon black (available from TIMCAL Graphite & Carbon in Bodio, Switzerland), and about 10% by weight KF W1300 polymer binder (available from KUREHA America Inc. in New York, N.Y.). During coating of the electrode layers, the above referenced materials may be mixed into slurry with N-Methyl-2-pyrrolidone solvent at about 50% solid content. The coated electrode layers may have a thickness corresponding to about 10 milligrams coating material per centimeter squared of anode surface area. The coated layer may then be compressed to a density of about 1.8 grams per centimeter cubed.

The cathode and anode are cut to the appropriate lengths and widths. In some embodiments, aluminum tabs may be welded (e.g., ultrasonically welded) to the clean/uncoated areas of the electrode (i.e., to the aluminum foil). The tabs may be between about 2.5-80 mm wide, or between about 3-20 mm wide, for example 4 mm wide. The tabs may be between about 0.05-0.2 mm thick, or between about 0.08-0.15 mm thick, for example 0.1 mm thick. Further, the tabs may be between about 5-200 mm long. These electrodes may be dried overnight under vacuum at an elevated temperature between about 60° C. to about 150° C., for example at about 100° C., and then may be wound with polypropylene separator (available from CELGARD in Charlotte, N.C.) into jellyrolls. In certain implementations the polypropylene separator is between about 12 to 40 micrometers thick, and in one example is about 25 micrometers thick. These jellyrolls may be dried under vacuum at about 60° C. to 150° C. for between about 4 to 72 hours, most commonly between about 12 to 48 hours. In one example, the jelly roll is dried at 60° C. for about 48 hours. The jellyrolls may then be inserted into steel tubes that are between about 3-100 millimeters long and between about 0.01-4 mm thick. In one example embodiment, the steel tube is 65 millimeter long, has an internal diameter of about 17.6 millimeters (to build 18650 types of cells), and has walls that are 0.2 millimeters thick

An anode tab may be welded (e.g., laser-welded) to one of the caps. The cap has an electrolyte facing surface formed from a material (e.g., aluminum) that is stable in the electrolyte environment at operating potentials of lithium titanium oxide. The cap may also incorporate a CID, safety valve (e.g., a rupture membrane), and ring-like PTC. The external surface of the cap may be nickel or nickel-plated material. The cap may be surrounded by an insulating gasket, and the case may be crimped around this assembly. The cell may then be filled with an electrolyte containing, e.g., about 1M LiPF₆ dissolved in approximately equal amounts of EC and EMC in certain embodiments. A cathode tab may be welded to another cap having the same structure as the first cap attached to the anode tab. This second cap may also be surrounded by an insulated gasket, and the case may be crimped around this assembly. The resulting cell may then proceed through C/10 charge/discharge formation cycle with voltage ranging from about 1.5V to 2.8V.

### Processing Example

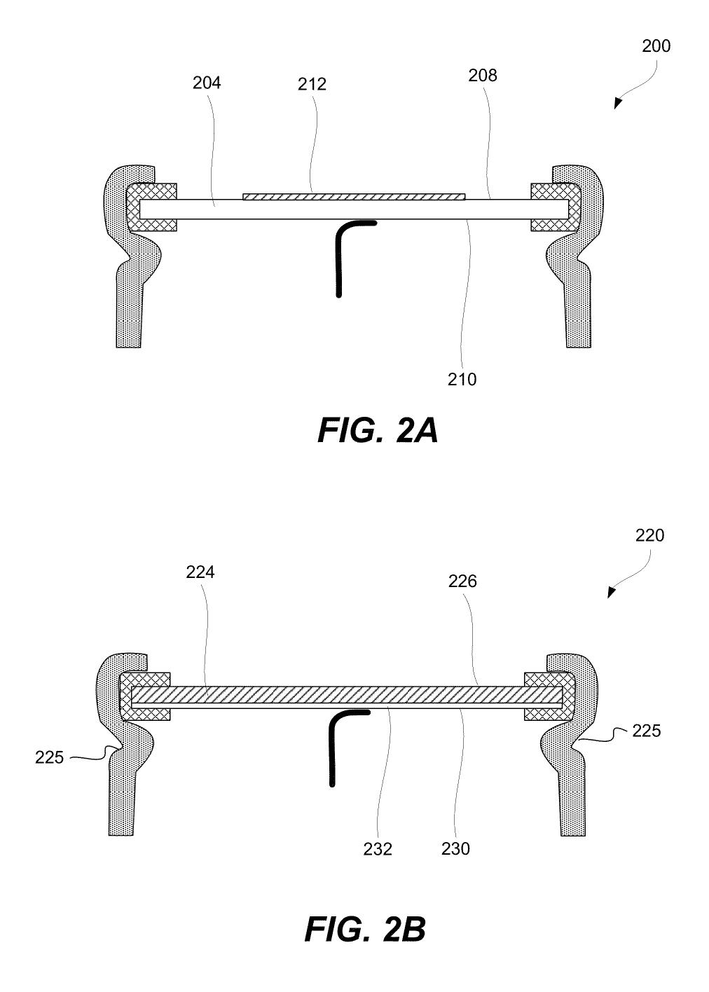

Provided herein are methods of fabricating an electrochemical cell assembly. FIG. 3 is a process flowchart corresponding to one such method 300, which involves providing a jellyroll subassembly having an anode and a cathode during operation 302. The anode may comprise lithium titanium oxide in certain embodiments. Method 300 may proceed with inserting the jellyroll subassembly into the case such that the case is electrically insulated from the cathode and the anode after insertion during operation 304. Method 300 may also involve establishing an electrical connection between the anode and a first cap during operation 306. The first cap may have a first electrolyte facing surface comprising a material that is electrochemically stable at the operating potentials of lithium titanium oxide. In the same or different operation, an electrical connection between the cathode and a second cap may be established. The second cap has a second electrolyte facing surface comprising, e.g., aluminum. Method 300 may involve sealing the first cap and/or the second cap with respect to the case to form a pre-fill subassembly during operation 308. The sealing may involve crimping or other forms of sealing described above. After this operation, the sealed cap(s) is electrically insulated from the case. Method 300 may involve filling an electrolyte into the pre-fill subassembly during operation 310.

### Experimental Results

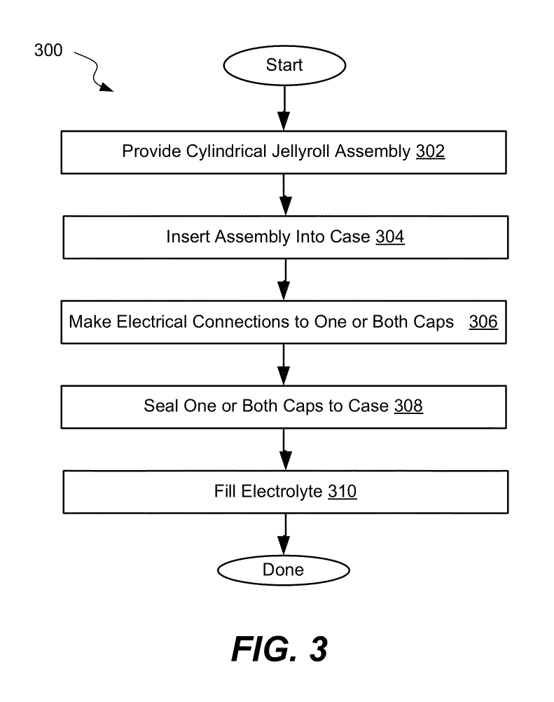

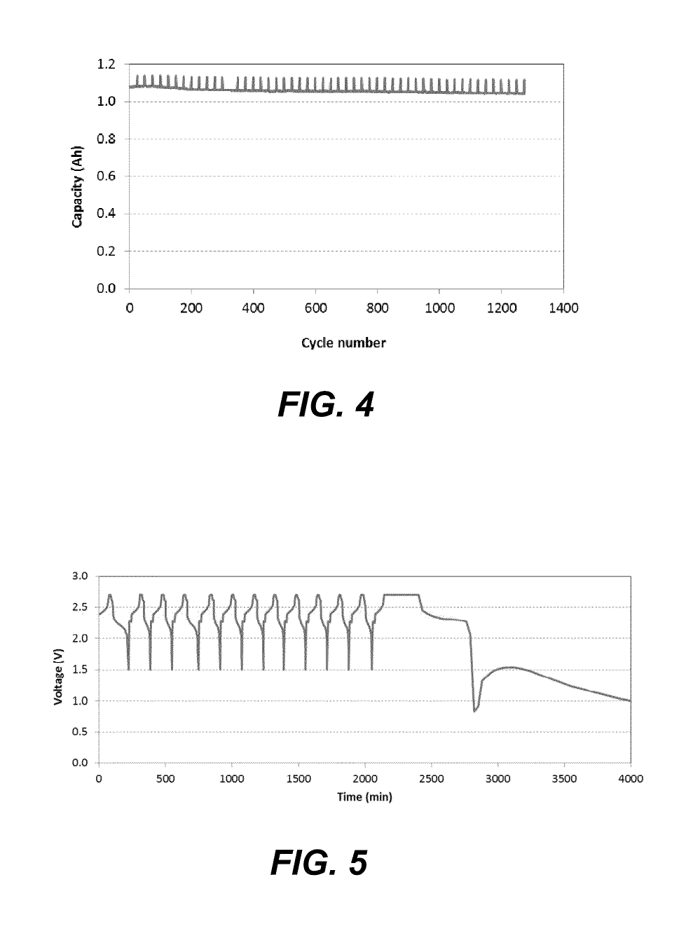

Experiments have been conducted to determine the cycling performance of cells. In these experiments, steel cases were connected to the anode of each cell. One cell was cycled at room temperature, and the corresponding cycling data (cell capacity vs. cycle number) is presented in FIG. 4. The cell testing was stopped after 1300 cycles. Another cell was cycled at 60° C., but it failed due to a short after a few cycles. The corresponding voltage vs. time data for this cell is presented in FIG. 5. When the second cell was disassembled, the case showed some corrosion on the electrolyte facing surface. At the same time, some metal deposits were found between the electrodes inside the cells, and it is believed that these metal deposits shorted the cell.

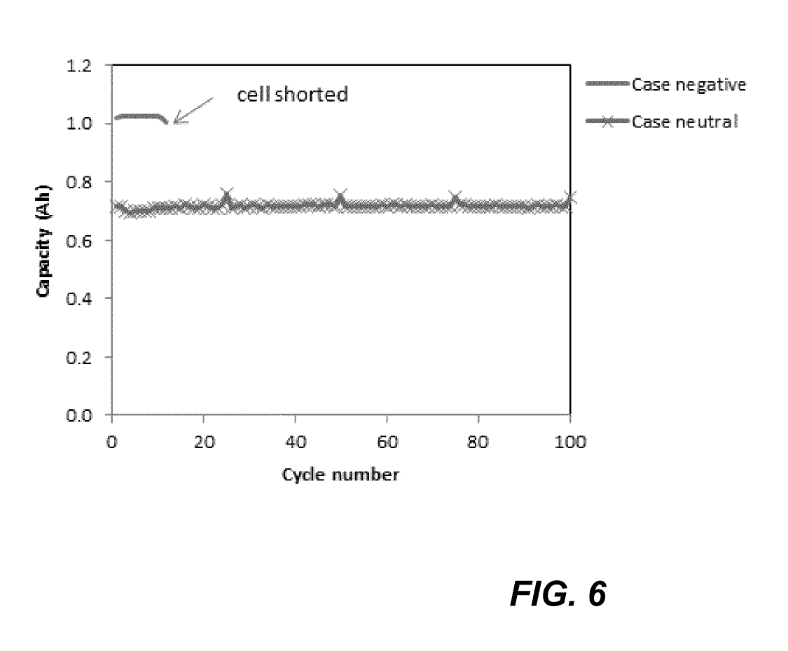

FIG. 6 compares the cycle life at 60° C. of a cell with an anode connected to a steel case with a cell having a neutral case. The two cells had different levels of total capacity. The cell with the neutral can had a slightly lower capacity, as shown in FIG. 6. However, in charging and discharging the cells, each of the two cells were discharged to approximately the same percentage of their total capacity, which was about 100%. In other words, although the cells had different levels of capacity, they were each completely (or nearly completely) drained during each discharge cycle. The cell with the neutral case continued to cycle for more than 500 cycles. Only the first 100 cycles are shown in the figure. The currents were 1 A on both charge and discharge. Every 25 cycles, 0.2 C discharges were performed. Higher capacity was achieved at 0.2 C rates, corresponding to the periodic spikes in the life cycle curve of FIG. 6. The cell with a negative case shorted after several cycles.

### Electrochemically Active Materials and Electrolytes

In certain embodiments, a cathode includes one or more active materials and a current collector. The cathode may have an upper charging voltage of about 3.5-4.5 volts versus a Li/Li⁻ reference electrode. The upper charging voltage is the maximum voltage to which the cathode may be charged at a low rate of charge and with significant reversible storage capacity. In some embodiments, cells utilizing a cathode with upper charging voltages from about 3-5.8 volts versus a Li/Li⁺ reference electrode are also suitable. In certain instances, the upper charging voltages are from about 3-4.2 volts, about 4.0-5.8 volts, or about 4.5-5.8 volts. In certain instances, the cathode has an upper charging voltage of about 5 volts. For example, the cell can have an upper charging voltage of about 4.9, 5.0, 5.1, 5.2, 5.3, 5.4, 5.5, 5.6, 5.7 or 5.8 volts. A variety of cathode active materials can be used. Non-limiting exemplary electrode active materials include transition metal oxides, phosphates and sulfates, and lithiated transition metal oxides, phosphates and sulfates.

In some embodiments, the electrode active materials are oxides with empirical formula LiₓMO₂, where M is a transition metal selected from the group consisting of Mn, Fe, Co, Ni, Al, Mg, Ti, V, Si, and a combination thereof, with a layered crystal structure. The value x may be between about 0.01 and about 1, between about 0.5 and about 1, or between about 0.9 and about 1.

In other embodiments, the electrode active materials are oxides with the formula LiₓM1ₐM2_{b}M3_{c}O₂, where M1, M2, and M3 are each independently a transition metal selected from the group Mn, Fe, Co, Ni, Al, Mg, Ti, V or Si. The subscripts a, b and c are each independently a real number between about 0 and 1 (0≦a≦1; 0≦b≦1; 0≦c≦1; 0.01≦x≦1.5), with the proviso that a+b+c is about 1.

In certain instances, the electrode active materials are oxides with the empirical formula LiₓNiₐCo_{b}Mn_{c}O₂, wherein the subscript x is between 0.01 and 1 (e.g., x is 1); the subscripts a, b and c are each independently 0, 0.1, 0.2, 0.3, 0.4, 0.5, 0.6, 0.7, 0.9 or 1, with the proviso that a+b+c is 1. In other instances, the subscripts a, b and c are each independently between about 0-0.5, between about 0.1-0.6, between about 0.4-0.7, between about 0.5-0.8, between about 0.5-1 or between about 0.7-1 with the proviso that a+b+c is about 1.

In yet other embodiments, the active materials are oxides with the empirical formula Li₁₊ₓA_{y}M_{2-y}O₄, where A and M are each independently a transition metal selected from the group consisting of Fe, Mn, Co, Ni, Al, Mg, Ti, V, and a combination thereof, with a spinel crystal structure. The value x may be between about −0.11 and 0.33, or between about 0 and about 0.1. The value of y may be between about 0 and 0.33, or between 0 and about 0.1. In one embodiment, A is Ni, x is 0 and y is 0.5 (i.e., the active material is LiA_{0.5}M_{1.5}O₄).

In yet some other embodiments the active materials are vanadium oxides such as LiV₂O₅, LiV₆O₁₃, or the foregoing compounds modified in that the compositions thereof are nonstoichiometric, disordered, amorphous, overlithiated or underlithiated.

The suitable cathode-active compounds may be further modified by doping with about 5% or less of divalent or trivalent metallic cations such as Fe²⁺, Ti²⁻, Zn²⁺, Ni²⁺, Co²⁺, Cu²⁺, Mg²⁺, Cr³⁺, Fe³⁺, Al³⁺, Ni³⁺ Co³⁺, or Mn³⁻, and the like. In other embodiments, cathode active materials suitable for the cathode composition include lithium insertion compounds with olivine structure such as LiₓMXO₄ where M is a transition metal selected from the group consisting of Fe, Mn, Co, Ni, and a combination thereof, and X is a selected from a group consisting of P, V, S, Si and combinations thereof, and the value of the value x is between about 0 and 2. In certain instances, the compound is LiMXO₄. In some embodiments, the lithium insertion compounds include LiMnPO₄, LiVPO₄, LiCoPO₄ and the like. In other embodiments, the active materials have NASICON structures such as YₓM₂(XO₄)₃, where Y is Li or Na, or a combination thereof, M is a transition metal ion selected from the group consisting of Fe, V, Nb, Ti, Co, Ni, Al, or the combinations thereof, and X is selected from a group consisting of P, S, Si, and combinations thereof, and the value of x is between 0 and 3. Examples of these materials are disclosed by J. B. Goodenough in “Lithium Ion Batteries” (Wiley-VCH press, Edited by M. Wasihara and O. Yamamoto). Particle size of the electrode materials may be between about 1 nm and about 100 μm, or between about 10 nm and about 100 μm, or between about 1 μm and 100 μm.

In other embodiments, the electrode active materials are oxides such as LiCoO₂, spinel LiMn₂O₄, chromium-doped spinel lithium manganese oxides LiₓCr_{y}Mn₂O₄, layered LiMnO₂, LiNiO₂, or LiNiₓCo₁₋ₓO₂, where x is between about 0 and 1, or between about 0.5 and about 0.95. The electrode active materials may also be vanadium oxides such as LiV₂O₅, LiV₆O₁₃, or the foregoing compounds modified in that the compositions thereof are nonstoichiometric, disordered, amorphous, overlithiated or underlithiated.

The suitable cathode-active compounds may be further modified by doping with about 5% or less of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³⁺ Co³⁺, or Mn³⁻, and the like. In yet other embodiments, cathode active materials suitable for the cathode composition include lithium insertion compounds with olivine structure such as LiFePO₄ and with NASICON structures such as LiFeTi(SO₄)₃. In still other embodiments, electrode active materials include LiFePO₄, LiMnPO₄, LiVPO₄, LiFeTi(SO₄)₃, LiNiₓMn₁₋ₓO₂, LiNiₓCo_{y}Mn_{1-x-y}O₂ and derivatives thereof, wherein x and y are each between about 0 and 1. In certain instances, x is between about 0.25 and 0.9. In one instance, x is ⅓ and y is ⅓. Particle size of the cathode active material should range from about 1 to 100 microns.

In some embodiments, the electrode-active material includes transition metal oxides such as LiCoO₂, LiMn₂O₄, LiNiO₂, LiNiₓMn₁₋ₓO₂, LiNiₓCo_{y}Mn_{1-x-y}O₂ and their derivatives, where x and y are each between about 0 and 1. LiNiₓMn₁₋ₓO₂ can be prepared by heating a stoichiometric mixture of electrolytic MnO₂, LiOH and nickel oxide to between about 300 and 400° C. In certain embodiments, the electrode active materials are xLi₂MnO₃(1−x)LiMO₂ or LiM′PO₄, where M is selected from the group consisting of Ni, Co, Mn, LiNiO₂ or LiNiₓCo₁₋ₓO₂; M′ is selected from the group consisting of Fe, Ni, Mn and V; and x and y are each independently a real number between about 0 and 1. LiNiₓCo_{y}Mn_{1-x-y}O₂ can be prepared by heating a stoichiometric mixture of electrolytic MnO₂, LiOH, nickel oxide and cobalt oxide to between about 300 and 500° C. The cathode may contain conductive additives from 0% to about 90%. In one embodiment, the subscripts x and y are each independently selected from 0.1, 0.15, 0.2, 0.25, 0.3, 0.35, 0.4, 0.45, 0.5, 0.55, 0.6, 0.65, 0.7, 0.75, 0.8, 0.85, 0.9 or 0.95. x and y can be any numbers between 0 and 1 to satisfy the charge balance of the compounds LiNiₓMn₁₋ₓO₂ and LiNiₓCo_{y}Mn_{1-x-y}O₂.

Representative cathodes and their approximate recharged potentials include FeS₂ (3.0 V vs. Li/Li⁺), LiCoPO₄ (4.8 V vs. Li/Li⁻), LiFePO₄ (3.45 V vs. Li/Li⁺), Li₂FeS₂ (3.0 V vs. Li/Li⁺), Li₂FeSiO₄ (2.9 V vs. Li/Li⁺), LiMn₂O₄ (4.1 V vs. Li/L^{i+),} LiMnPO₄ (4.1 V vs. Li/L^{i+),} LiNiPO₄ (5.1 V vs. Li/Li⁺), LiV₃O₈ (3.7 V vs. Li/Li⁺), LiV₆O₁₃ (3.0 V vs. Li/Li⁺), LiVOPO₄ (4.15 V vs. Li/Li⁺), LiVOPO₄F (4.3 V vs. Li/Li⁺), Li₃V₂(PO₄)₃ (4.1 V (2 Li) or 4.6 V (3 Li) vs. Li/Li⁺), MnO₂ (3.4 V vs. Li/Li⁺), MoS₃ (2.5 V vs. Li/Li⁺), sulfur (2.4 V vs. Li/Li⁺), TiS₂(2.5 V vs. Li/Li⁺), TiS₃ (2.5 V vs. Li/Li⁺), V₂O₅ (3.6 V vs. Li/Li⁺), and V₆O₁₃ (3.0 V vs. Li/Li⁺) and combinations thereof.

A cathode can be formed by mixing and forming a composition comprising, by weight, between about 0.01-15% (e.g., between about 4-8%) polymer binder, between about 10-50% (e.g., between about 15-25%) electrolyte solution as herein described, between about 40-85% (e.g., between about 65-75%) electrode-active material, and between about 1-12% (e.g., between about 4-8%) conductive additive. An inert filler may also be added up to about 12% by weight, though in certain cases no inert filler is used. Other additives may be included, as well.

An anode may include active materials and a current collector. The anode comprises either a metal selected from the group consisting of Li, Si, Sn, Sb, Al and a combination thereof, or a mixture of one or more anode active materials in particulate form, a binder (in certain cases a polymeric binder), optionally an electron conductive additive, and at least one organic carbonate. Examples of useful anode active materials include, but are not limited to, lithium metal, carbon (graphites, coke-type, mesocarbons, polyacenes, carbon nanotubes, carbon fibers, and the like). Anode-active materials also include lithium-intercalated carbon, lithium metal nitrides such as Li_{2.6}Co_{0.4}N, metallic lithium alloys such as LiAl, Li₄Sn, or lithium-alloy-forming compounds of tin, silicon, antimony, or aluminum. Further included as anode-active materials are metal oxides such as titanium oxides, iron oxides, or tin oxides.

When present in particulate form, the particle size of the anode active material should range from about 0.01 to 100 microns, e.g., from 1 to 100 microns. In some cases the anode active materials include graphites such as carbon microbeads, natural graphites, carbon nanotubes, carbon fibers, or graphitic flake-type materials. Alternatively or in addition, the anode active materials may be graphite microbeads and hard carbon, which are commercially available.

An anode can be formed by mixing and forming a composition comprising, by weight, between about 2-20% (e.g., 3-10%) polymer binder, between about 10-50% (e.g., between about 14-28%) electrolyte solution as described herein, between about 40-80% (e.g., between about 60-70%) electrode-active material, and between about 0-5% (e.g., between about 1-4%) conductive additive. In certain cases an inert filler is added up to about 12% by weight, though in other cases no filler is used. Additional additives may also be present.

Suitable conductive additives for the cathode and anode composition include carbons such as coke, carbon black, carbon nanotubes, carbon fibers, and natural graphite, metallic flake or particles of copper, stainless steel, nickel or other relatively inert metals, conductive metal oxides such as titanium oxides or ruthenium oxides, or electrically-conductive polymers such as polyacetylene, polyphenylene and polyphenylenevinylene, polyaniline or polypyrrole. Additives may include, but are not limited to, carbon fibers, carbon nanotubes and carbon blacks with a surface area below ca. 100 m2/g such as Super P and Super S carbon blacks available from MMM Carbon in Belgium.

The current collector suitable for the cathode and anode includes a metal foil and a carbon sheet selected from a graphite sheet, carbon fiber sheet, carbon foam and carbon nanotube sheet or film. High conductivity is generally achieved in pure graphite and pure carbon nanotube films. Therefore, the graphite and nanotube sheeting should contain as few binders, additives and impurities as possible in order to realize the benefits of the present embodiments. Carbon nanotubes can be present from about 0.01% to about 99% by weight. The carbon fiber can be in the micron or submicron range. Carbon black or carbon nanotubes may be added to enhance the conductivities of certain carbon fibers. In one embodiment, the anode current collector is a metal foil, such as copper foil. The metal foil can have a thickness between about 5 and about 300 micrometers.

The carbon sheet current collector suitable for the present invention may be in the form of a powder coating on a substrate such as a metal substrate, a free-standing sheet, or a laminate. In other words, the current collector may be a composite structure having other members such as metal foils, adhesive layers, and such other materials as may be considered desirable for a given application. However, in any event, according to the present embodiments, it is the carbon sheet layer, or carbon sheet layer in combination with an adhesion promoter, which directly interfaces with the electrolyte and is in electrically conductive contact with the electrode surface.

Suitable binders include, but are not limited to, polymeric binders, particularly gelled polymer electrolytes comprising polyacrylonitrile, poly(methylmethacrylate), poly(vinyl chloride), and polyvinylidene fluoride and copolymers thereof. Also included are solid polymer electrolytes such as polyether-salt based electrolytes including poly(ethylene oxide)(PEO) and its derivatives, poly(propylene oxide) (PPO) and its derivatives, and poly(organophosphazenes) with ethyleneoxy or other side groups. Other suitable binders include fluorinated ionomers comprising partially or fully fluorinated polymer backbones, and having pendant groups comprising fluorinated sulfonate, imide, or methide lithium salts. Preferred binders include polyvinylidene fluoride and copolymers thereof with hexafluoropropylene, tetrafluoroethylene, fluorovinyl ethers, such as perfluoromethyl, perfluoroethyl, or perfluoropropyl vinyl ethers; and ionomers comprising monomer units of polyvinylidene fluoride and monomer units comprising pendant groups comprising fluorinated carboxylate, sulfonate, imide, or methide lithium salts.

The electrochemical cell optionally contains an ion conductive layer or a separator. The ion conductive layer suitable for the lithium or lithium-ion battery of the present embodiments is any ion-permeable layer, preferably in the form of a thin film, membrane or sheet. Such ion conductive layer may be an ion conductive membrane or a microporous film such as a microporous polypropylene, polyethylene, polytetrafluoroethylene and layered structures thereof. Suitable ion conductive layers also include swellable polymers such as polyvinylidene fluoride and copolymers thereof. Other suitable ion conductive layers include gelled polymer electrolytes such as poly(methyl methacrylate) and poly(vinyl chloride). Also suitable are polyethers such as poly(ethylene oxide) and poly(propylene oxide). In some cases, preferable separators are microporous polyolefin separators or separators comprising copolymers of vinylidene fluoride with hexafluoropropylene, perfluoromethyl vinyl ether, perfluoroethyl vinyl ether, or perfluoropropyl vinyl ether, including combinations thereof, or fluorinated ionomers.

An electrolyte may include various carbonates, such as cyclic carbonates and linear carbonates. Some examples of cyclic carbonates include ethylene carbonate (EC), propylene carbonate (PC), butylene carbonate (BC), vinylene carbonate (VC), dimethylvinylene carbonate (DMVC), vinylethylene carbonate (VEC), and fluoroethylene carbonate (FEC). The cyclic carbonate compounds may include at least two compounds selected from the group consisting of ethylene carbonate, propylene carbonate, vinylene carbonate, vinylethylene carbonate, and fluoroethylene carbonate. Some examples of linear-carbonate compounds include linear carbonates having an alkyl group, such as dimethyl carbonate (DMC), methyl ethyl carbonate (MEC), diethyl carbonate (DEC), methyl propyl carbonate (MPC), dipropyl carbonate (DPC), methyl butyl carbonate (MBC) and dibutyl carbonate (DBC). The alkyl group can have a straight or branched chain structure.

Examples of other non-aqueous solvents include lactones such as gamma-butyrolactone (GBL), gamma-valerolactone, and alpha-angelica lactone; ethers such as tetrahydrofuran, 2-methyltetrahydrofuran, 1,4-dioxane, 1,2-dimethoxyethane, 1,2-diethoxyethane, and 1,2-dibutoxyethane; nitriles such as acetonitrile, and adiponitrile; linear esters such as methyl propionate, methyl pivalate, butyl pivalate, hexyl pivalate, octyl pivalate, dimethyl oxalate, ethyl methyl oxalate, and diethyl oxalate; amides such as dimethylformamide; and compounds having an S.dbd.O bonding such as glycol sulfite, propylene sulfite, glycol sulfate, propylene sulfate, divinyl sulfone, 1,3-propane sultone, 1,4-butane sultone, and 1,4-butanediol dimethane sulfonate.

Examples of combinations of the non-aqueous solvents include a combination of a cyclic carbonate and a linear carbonate, a combination of a cyclic carbonate and a lactone, a combination of a cyclic carbonate, a lactone and a linear ester, a combination of a cyclic carbonate, a linear carbonate and a lactone, a combination of a cyclic carbonate, a linear carbonate and an ether, and a combination of a cyclic carbonate, a linear carbonate and a linear ester. Preferred are the combination of a cyclic carbonate and a linear carbonate, and the combination of a cyclic carbonate, a linear carbonate and a linear ester.

Examples of electrolyte salts used in non-aqueous electrolytic solutions include: LiPF₆, LiBF₄, LiClO₄; lithium salts comprising a chain alkyl group such as LiN(SO₂CF₃)₂, LiN(SO₂C₂F₅)₂, LiC(SO₂CF₃)₃, LiPF₄(CF₃)₂, LiPF₃(C₂F₅)₃, LiPF3(CF3)3, LiPF₃(iso-C₃F₇)₃, and LiPF₅(iso-C₃F₇); and lithium salts comprising a cyclic alkylene group such as (CF₂)₂(SO₂)2NLi, and (CF₂)₃(SO₂)2NLi. More preferred are LiPF₆, LiBF₄ and LiN(SO₂CF₃)₂, and most preferred is LiPF₆, though these preferential ingredients are in no way limiting.

The electrolyte salt can be used singly or in combination. Examples of the preferred combinations include a combination of LiPF₆ with LiBF₄, a combination of LiPF₆ with LiN(SO₂CF₃)₂, and a combination of LiBF₄ with LiN(SO₂CF₃)₂. Most preferred is the combination of LiPF₆ with LiBF₄, though again, these preferential combinations are in no way limiting. There is no specific limitation with respect to the mixing ratio of the two or more electrolyte salts. In the case that LiPF₆ is mixed with other electrolyte salts, the amount of the other electrolyte salts preferably is about 0.01 mole % or more, about 0.03 mole % or more, about 0.05 mole % or more based on the total amount of the electrolyte salts. The amount of the other electrolyte salts may be about 45 mole % or less based on the total amount of the electrolyte salts, about 20 mole % or less, about 10 mole % or less, or about 5% mole % or less. The concentration of the electrolyte salts in the non-aqueous solvent may be about 0.3 M or more, about 0.5 M or more, about 0.7 M or more, or about 0.8 M or more. Further, the electrolyte salt concentration preferably is about 2.5 M or less, about 2.0 M or less, about 1.6 M or less, or about 1.2 M or less.

### Battery Packs

Provided herein also are battery packs, each containing one or more electrochemical cells built with processed active materials. When a battery pack includes multiple cells, these cells may be configured in series, in parallel, or in various combinations of these two connection schemes. In addition to cells and interconnects (electrical leads), battery packs may include charge/discharge control systems, temperature sensors, current balancing systems, and other like components. For example, battery regulators may be used to keep the peak voltage of each individual cell below its maximum value so as to allow weaker batteries to be fully charged, bringing the whole pack back into balance. Active balancing can also be performed by battery balancer devices which can shuttle energy from stronger batteries to weaker ones in real time for improved balance.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. An electrochemical cell assembly comprising:
an anode comprising lithium titanium oxide,
a cathode wound into a jellyroll subassembly together with the anode;
an electrolyte providing ionic communication between the cathode and anode;
a first cap in electrical communication with the anode, the first cap having a first electrolyte facing surface comprising a material that is electrochemically stable at operating potentials of the lithium titanium oxide;
a second cap in electrical communication with the cathode, the cap having a second electrolyte facing surface comprising aluminum; and
a case attached to and insulated from the first cap at a first end of the case and attached to and insulated from the second cap at a second end of the case, the case being electrically insulated from the cathode and the anode of the jellyroll subassembly positioned within the case.

2. The electrochemical cell assembly of claim 1, wherein the case, the first cap, and the second cap are round.

3. The electrochemical cell assembly of claim 1, further comprising a first insulating gasket provided between the first cap and the case at the first end and a second insulating gasket provided between the second cap and the case at the second end.

4. The electrochemical cell assembly of claim 3, wherein the case is crimped around the first insulating gasket and the first cap, and wherein the case is crimped around the second insulating gasket and the second cap.

5. The electrochemical cell assembly of claim 4, wherein the case comprises steel.

6. The electrochemical cell assembly of claim 4, wherein the case comprises a nickel coating provided on an electrolyte facing surface of the case.

7. The electrochemical cell assembly of claim 3, wherein the case comprises a first protrusion at the first end of the case, the first protrusion interlocking with the first insulating gasket.

8. The electrochemical cell assembly of claim 3, wherein the case comprises a second protrusion at the second end of the case, the second protrusion interlocking with the second insulating gasket.

9. The electrochemical cell assembly of claim 1, wherein the first cap comprises a nickel surface opposite of the first electrolyte facing surface.

10. The electrochemical cell assembly of claim 9, wherein the nickel surface is formed by depositing a nickel containing layer onto the first cap comprising aluminum.

11. The electrochemical cell assembly of claim 1, wherein the first electrolyte facing surface is formed by depositing an aluminum containing layer onto the first cap comprising nickel, and wherein the aluminum containing layer extends throughout the entire first electrolyte facing surface thereby preventing contact between nickel of the first cap and electrolyte.

12. The electrochemical cell assembly of claim 1, further comprising an auxiliary electrode electrically connected to the case and exposed to the electrolyte.

13. The electrochemical cell assembly of claim 12, wherein the auxiliary electrode comprises lithium.

14. The electrochemical cell assembly of claim 12, wherein the auxiliary electrode is provided between the case and the jellyroll subassembly, and wherein the auxiliary electrode is electrically connected to the case by the jellyroll subassembly forcing the auxiliary electrode against the case.

15. The electrochemical cell assembly of claim 1, wherein the jellyroll subassembly further comprises a separator providing electrical insulation between the anode and the case and/or between the cathode and the case.

16. A method of fabricating an electrochemical cell assembly, the method comprising:
providing a jellyroll subassembly comprising an anode and a cathode, the anode comprising lithium titanium oxide;
inserting the jellyroll subassembly into the case such that the case is electrically insulated from the cathode and the anode after inserting;
establishing an electrical connection between the anode and a first cap, the first cap having a first electrolyte facing surface comprising a material that is electrochemically stable at operating potentials of the lithium titanium oxide;
establishing an electrical connection between the cathode and a second cap, the second cap having a second electrolyte facing surface comprising aluminum;
sealing the first cap and/or the second cap with respect to the case to form a pre-fill subassembly, wherein the sealed cap and/or caps are electrically insulated from the case after the sealing; and
filling electrolyte into the pre-fill subassembly.

17. The method of claim 16, wherein the pre-fill subassembly further comprises an auxiliary electrode electrically connected to the case and exposed to the electrolyte after filling.
